(19) United States
(12) Patent Application Publication
(10) Pub. No.: US 2023/0197980 A1
(43) Pub. Date: Jun. 22, 2023

(54) FUEL CELL STRUCTURE, FUEL CELL STACK, AND MOTOR VEHICLE HAVING A FUEL CELL DEVICE

(71) Applicants: AUDI AG, Ingolstadt (DE); VOLKSWAGEN AG, Wolfsburg (DE)

(72) Inventors: Alexander FLADUNG, Ammersbek (DE); Matthias RECKERS, Braunschweig (DE)

(21) Appl. No.: 17/925,588

(22) PCT Filed: May 11, 2021
(86) PCT No.: PCT/EP2021/062410

§ 371 Date: Nov. 15, 2022

(30) Foreign Application Priority Data
May 18, 2020 (DE) 10 2020 113 354.5

(51) Int. Cl. H01M 8/0265; H01M 8/1004; H01M 8/0273; H01M 8/242

(52) U.S. Cl. CPC H01M 8/0265; H01M 8/242; H01M 8/0273; H01M 8/1004; H01M 2008/1095

(57) ABSTRACT

A fuel cell structure has a membrane electrode assembly , a polar plate mounted in a stacking direction for supplying a reactant to a surface of the membrane electrode assembly, the polar plate comprising a media port as the inlet for the reactant and a media port as the outlet for the reactant as well as a flow field which fluidically connects the two media ports, and an active area being provided in which the electrochemical fuel cell reaction occurs during operation, and a means for producing a region with a reduced reactant flow, which is provided on the inlet side of the flow field . The means is located within the active area at the edge, or extends into the active area at the edge. A fuel cell stack and a motor vehicle including the aforementioned fuel cell structure is also provided.

### BACKGROUND

### Technical Field

Embodiments of the invention relate to a fuel cell structure having a membrane electrode assembly, a polar plate mounted in a stacking direction for supplying a reactant to a surface of the membrane electrode assembly, the polar plate comprising a media port as the inlet for the reactant and a media port as the outlet for the reactant as well as a flow field which fluidically connects the two media ports, in particular comprising a plurality of flow channels separated by webs, and an active area (A) being provided in which the electrochemical fuel cell reaction occurs during operation, and a means for producing a region with a reduced reactant flow, which is provided on the inlet side of the flow field. Embodiments of the invention furthermore relate to a fuel cell stack having such a fuel cell structure and a motor vehicle having a fuel cell device with such a fuel cell stack.

### Description of the Related Art

Such a structure of a fuel cell comprises a membrane electrode assembly formed from a proton-conducting membrane, on one side of which the anode is formed and on its other side the cathode. The electrodes are supplied with reactant gases by means of the polar plates, namely, hydrogen in particular at the anode side and oxygen or an oxygen-containing gas, especially air, at the cathode side. When supplying the fuel cell with the reactants, these are conveyed through a channel into the polar plate, which utilizes a plurality of channels to distribute the reactant in order to supply the entire surface of the electrodes as evenly as possible. Unused reactants are taken away once more through a gas outlet channel. During the electrochemical reaction, product water is also produced from the educts, especially on the cathode side, but product water also gets onto the anode side through diffusion or osmosis. It is therefore necessary to remove the liquid water so that the fuel cell can be operated reliably and sustainably. The polar plates are also used at the same time for the conveying of a coolant. It is thus necessary to separate the various gas and coolant channels reliably and seal them off from each other. When multiple fuel cells are arranged in a row in a fuel cell stack, the polar plates not at the end positions are generally configured as bipolar plates, being also used for the electrical contacting of the electrodes to pass on the current to the neighboring cell. Thus, the polar plates constitute an important element of a fuel cell structure or a fuel cell stack and provide for a number of functions.

The moisture content of the membrane of a fuel cell has substantial influence on its efficiency, as well as its service life. The membrane is typically saturated with moisture, since this favors the proton transport and minimizes the ablation of material from the membrane with consequent damage. On account of the flowing reactant, an unequal distribution of moisture over the active surface of the membrane may occur, since for example a higher concentration of reactant is present at the inlet side of the active area than that on the outlet side of the active surface. At the same time, different pressure relations occur, which likewise influence the diffusion of water molecules over the membrane, so that typically dryer areas of the membrane are usually present at the inlet side than those at the outlet side.

In US 2012 / 0 122 009 A1, a bipolar plate is described, being associated with an encircling edge seal produced by injection molding for the lateral sealing off of the membrane. In DE 10 2009 009 177 A1, a bipolar plate is described having a barrier for the flowing reactant outside of the active area, so that an equalization of the heat distribution over the active area is achieved by creating turbulence. In US 2003 / 0 104 261 A1, a fuel cell structure is described in which the possibility of saturating the membrane with moisture is afforded by mixing in the cathode gas with the fuel in order to produce liquid water and thereby moisten the membrane.

### BRIEF SUMMARY

Some embodiments provide a fuel cell structure in which a more even distribution of moisture over the membrane is accomplished. Some embodiments indicate a fuel cell stack as well as a motor vehicle.

A fuel cell structure may include the means located within the active area at the edge, or extending into the active area at the edge. Hence, a means for producing a region with a reduced reactant flow, especially a dead zone for reactant, exists at the edge and at the inlet on the active area, so that a drying out of the membrane there is prevented by virtue of the flow and the temperature of the reactant. Thus, a more even distribution of moisture over the membrane can be realized.

For an easier fabrication, especially when the fuel cell structure is made by a pressing technique, the flow field and the media ports may be framed by a seal for lateral sealing off of the membrane electrode assembly, and the means extending into the active area is embedded in the seal. This means may be for example a metal or plastic strip, protruding into the active area and thus presenting a kind of “hill” to the oncoming reactant flow. Beneath or behind the “hill” there is formed a region with a reduced reactant flow, in particular a dead zone, where no reactant is present.

Alternatively or additionally, the possibility exists of having the means embedded in a gas diffusion layer situated between the polar plate and the membrane electrode assembly in the stacking direction, so that this can also realize a kind of “hill” for the oncoming medium, and behind the “hill” there is formed a region with a reduced reactant flow, in particular a dead zone.

A strip extending at an angle relative to the surface normal of the surface of the membrane electrode assembly only partly into a usable flow cross section of at least one of the flow channels of the polar plate has proven to be an especially effective means. This can be a metal strip, or also a plastic strip. Such a strip may also be installed in or protrude into multiple channels along the direction of extension perpendicular to the direction of flow of the reactant.

The manufacturing of the fuel cell structures can be made easier when an extra plate is present between the polar plate and the membrane electrode assembly, comprising a plurality of strips protruding into the flow channels of the polar plate. Thus, the extra plate can be placed against the polar plate, not being deformed in the region of the webs. In the region of the flow channels, however, there is formed a protruding strip, in particular one that is punched out, and protruding only partly into the respective flow channel in order to decrease the flow cross section of the flow channel.

By “at an angle” is meant configurations in which the strip is oriented neither perpendicular nor parallel to the surface of the membrane electrode assembly, so that the corresponding “hill” can be realized to create a region with a reduced reactant flow.

Since with increasing extension of the flow channel the pressure of the reactant decreases by virtue of being consumed in the electrochemical reaction, it has proven to be advantageous when a series of strips is installed in at least one of the flow channels in the flow direction of the reactant flow.

In this context, the possibility exists for the usable flow cross section of the flow channel provided by a first strip to be smaller than that of a second strip situated downstream from the first strip. Downstream regions of the membrane are not as dry as those located closer to the inlet media port, so that the regions with a reduced reactant flow are more pronounced near the inlet.

An equalization of the distribution of moisture can also be achieved in that the means is formed from a depression, recess or concavity of the membrane electrode assembly at the edge, so that the reactant flow cannot enter into this depression and dry out the membrane.

The fabrication of the fuel cell structures is simplified when an elastomer is used for the seal that is chosen from the group comprising silicone, ethylene-propylene-diene rubber (EPDM), polyisobutylene. The use of other elastomers with suitable properties is likewise conceivable.

The polar plate itself is formed from a material formed from metal, especially from a high-alloy steel. For example, steel with grade 1.4404 can be mentioned. Alternatively, the polar plate is formed from a carbon-based material.

A fuel cell stack composed of fuel cells having the above fuel cell structure is distinguished by a longer service life on account of an improved water management of the individual membranes. The benefits and advantageous effects explained for the fuel cell structure described herein apply equally to the fuel cell stack described herein.

The benefits and advantageous effects mentioned above also apply accordingly to a motor vehicle having a fuel cell device with such a fuel cell stack, being distinguished as well by longer maintenance intervals on account of the longer service life of the fuel cells in the stack. This results in a more efficient and economical motor vehicle.

The features and combinations of features mentioned in the specification, as well as the features and combinations of features mentioned below in the description of the figures and/or shown only in the figures, can be used not only in the particular indicated combination, but also in other combinations or standing alone. Thus, embodiments which are not explicitly shown or explained in the figures, yet which emerge from and can be created by separate combinations of features from the embodiments which have been explained, should also be seen as being encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a fuel cell device.

FIG. 2 shows a schematic representation of a top view looking onto the surface of a polar plate, with a detail illustrating the diffusion of H₂O.

FIG. 3 shows the means formed as a strip, being partly embedded in a seal for lateral sealing off of the membrane electrode assembly (“subgasket”).

FIG. 4 shows an extra region in side view having multiple strips to create a region with reduced reactant flow.

FIG. 5 shows a cutout view of a top view looking down on the extra plate of FIG. 4 mounted on the polar plate.

FIG. 6 shows the polar plate with extra plate and detail cutouts at two different positions of the polar plate.

FIG. 7 shows a means formed as a depression of the membrane electrode assembly in a cross-sectional representation.

### DETAILED DESCRIPTION

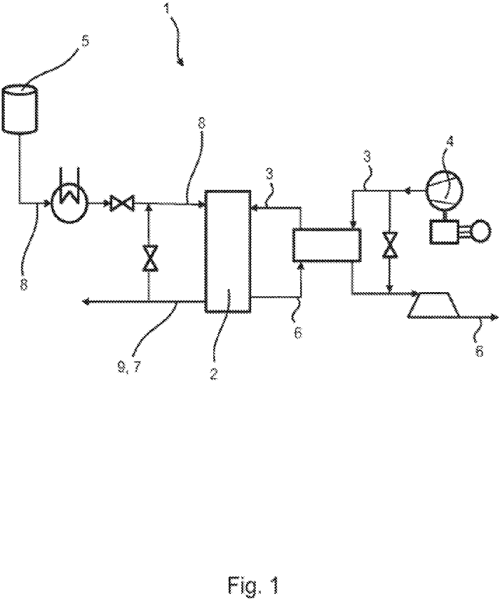

FIG. 1 shows schematically a fuel cell device 1, comprising a fuel cell or a plurality of fuel cells assembled into a fuel cell stack 2.

Each of the fuel cells comprises a membrane electrode assembly 20, composed of an anode and a cathode, as well as a proton-conducting membrane which separates the anode from the cathode. The membrane is formed from an ionomer, such as a sulfonated tetrafluorethylene polymer (PTFE) or a polymer of perfluorinated sulfonic acid (PFSA). Alternatively, the membrane can also be formed as a sulfonated hydrocarbon membrane.

The anodes and/or the cathodes may also have a catalyst mixed in with them, and the membranes may be coated on their first side and/or on their second side with a catalyst layer consisting of a precious metal or a mixture containing precious metals, such as platinum, palladium, ruthenium or the like, serving as a reaction accelerant in the reaction of the particular fuel cell.

Through anode spaces within the fuel cell stack 2, fuel, such as hydrogen, is supplied to the anodes. In a polymer electrolyte membrane fuel cell (PEM fuel cell), fuel or fuel molecules are split up into protons and electrons at the anode. The membrane lets the protons (for example H⁺) pass through, but is not permeable to the electrons (e⁻). At the anode, the following reaction will occur: 2H₂ → 4H⁺ + 4e⁻ (oxidation/electron donation). While the protons pass through the membrane to the cathode, the electrons are taken by an external circuit to the cathode or to an energy accumulator. Through cathode spaces likewise provided by the bipolar plate 10 within the fuel cell stack 2, the cathode gas (such as oxygen or air containing oxygen) can be supplied to the cathodes, so that at the cathode side the following reaction will occur: O₂ + 4H⁺ + 4e⁻→ 2H₂O (reduction/electron uptake).

Air compressed by a compressor 4 is supplied to the fuel cell stack 2 through a cathode fresh gas line 3. In addition, the fuel cell is connected to a cathode exhaust gas line 6. At the anode side, hydrogen from a hydrogen tank 5 is supplied to the fuel cell stack 2 by an anode fresh gas line 8 in order to provide the reactant needed for the electrochemical reaction in a fuel cell. These gases are conveyed or removed by means of a media port 15 in polar plates and bipolar plates 10 on their active surface A, flow channels 11 being formed in the polar plate and bipolar plate 10 and separated by webs 13 for the further distributing of the gases on the membrane electrode assembly 20 and for their drainage from the fuel cell stack 2 and the circulation of a coolant.

A valve or a suction jet pump may be suitable for producing the desired partial pressure on fresh fuel inside an anode circuit, created by the anode recirculation line 7. With such an anode recirculation line 7, the fuel not consumed in the fuel cell stack 2 can be supplied once more to the anode spaces, upstream from the fuel cell, so that the anode recirculation line 7 empties once more into the anode fresh gas line 8. Consumed fuel is removed from the fuel cell through the anode exhaust gas line 9.

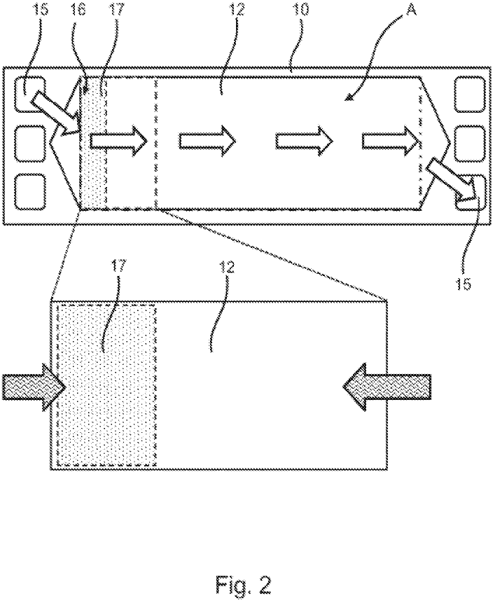

FIG. 2 illustrates a bipolar plate 10 in which three media ports 15 are provided, shown at left, for the supply of the two reactants and the coolant, and three media ports 15, shown at right, for their drainage. Purely as an illustration, the fuel flow is shown from the upper left media port 15 to the lower right media port 15, being distributed across the bipolar plate 10 or its flow field 12. The flow field 12 has flow channels 11, not otherwise shown, which are separated by webs 13. In the dotted region, the electrochemical reaction takes place, since in this region the membrane electrode assembly 20 is coated on both sides by the two reaction media. This dotted region is thus the active area A. Because of the existing reactant flow, there is an intensified drying of the membrane of the membrane electrode assembly 20 at the inlet side, i.e., near the upper left media port 15 illustrated. Thus, the dry region highlighted by the dots is produced, illustrating the diffusion of H₂O by the wavy arrows. A means 16 is present for producing a region 17 in which a reduced reactant flow prevails, the means 16 being located at the edge within the active area A or at least extending into the active area A at the edge. This prevents a stronger drying of the membrane near the inlet, resulting in an uneven moisture distribution over the membrane of the membrane electrode assembly 20.

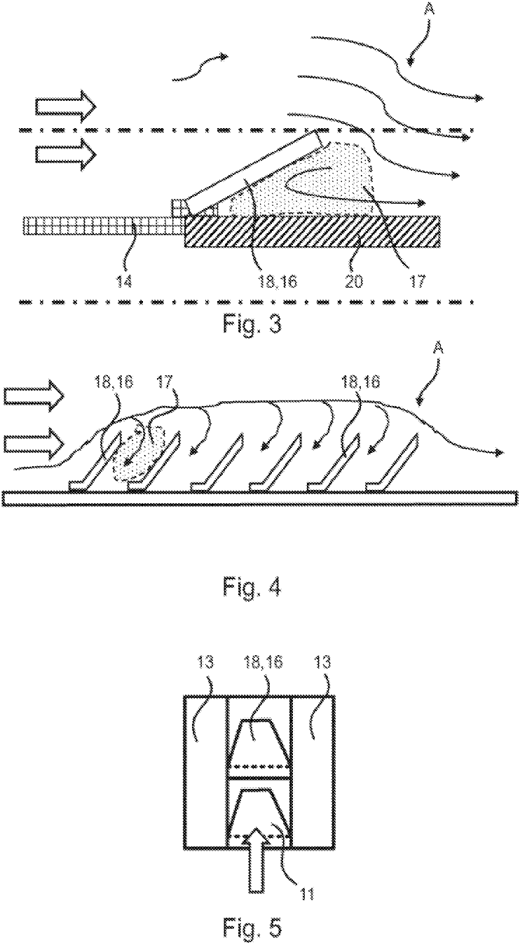

FIG. 3 shows a schematic side view, the means being formed from a strip 18 which is embedded in a seal 14. This seal 14 encloses the flow field 12 and the media ports 15; of course, this enclosure only applies to the media port 15 for the inlet and the outlet of a single one of the three media present. The seal 14 serves for lateral sealing off of the membrane electrode assembly 20, the means 16,18 extending into the active area A, starting from the seal 14. It is also possible for the means 16 shown in FIG. 3 to not be embedded in the seal 14, but rather in a gas diffusion layer situated between the polar plate 10 and the membrane electrode assembly 20 in the stacking direction, being illustrated by dash-dotting.

FIG. 4 refers to the possibility of the means 16 being formed as at least one strip 18, which extends only partly, at an angle relative to the surface normal in the surface of the membrane electrode assembly 20, into a usable flow cross section of at least one of the flow channels 11 of the bipolar plate 10. In the present case, a series of strips 18 is shown, while each strip 18 can form its own dead zone 17. These strips 18 thus form a kind of “hill” for the reactant flow arriving at them. The strips 18 may be part of an extra plate, yet to be described.

FIG. 5 is a top view of the strips 18 arranged in the flow channels 11. All the strips 18 in this case are formed on the extra plate, being created in particular by a punching process. In the region of the webs 13 the extra plate is not deformed, while in the region of the flow channels 11 the strips 18 protrude only partly into the usable flow cross section.

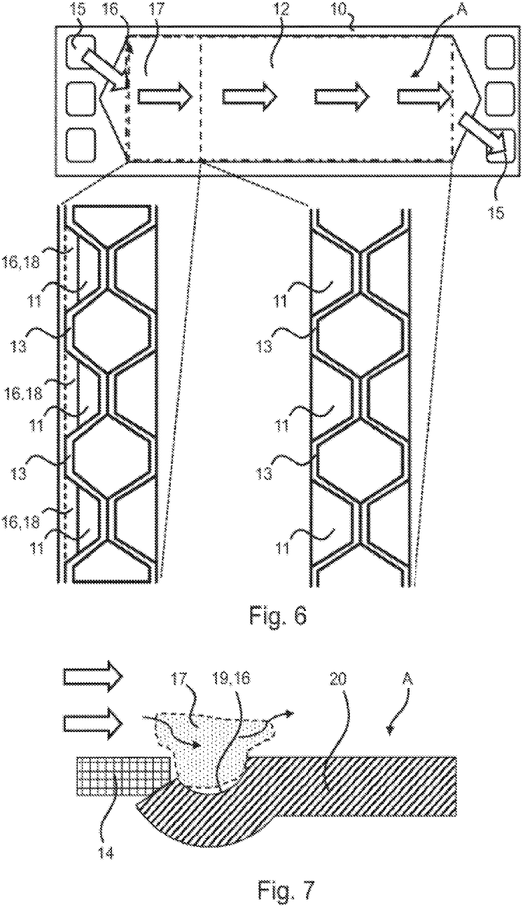

This only partial protrusion into the flow channel 11 can also be noticed in the illustration of FIG. 6, where the flow cross section for the fuel is reduced by the “hills” or strips 18 partly protruding into the flow channels 11. But this reduction of the flow cross section is present only in the active area A and also only at the inlet side.

FIG. 7 refers to the possibility of the means 16 being also formed by an edge-side depression 19 of the membrane electrode assembly 20, so that here as well a smaller portion of the reactant flow comes into contact with the membrane electrode assembly 20 and thus results in less drying out of the membrane. This depression 19 alternatively or additionally may also be present in the gas diffusion layer adjacent to the membrane electrode assembly 20.

The fuel cell structure described herein, the fuel cell stack 2 described herein, and the motor vehicle described herein are distinguished by a longer service life and therefore longer intervals between maintenance. This involves not only an efficiency, but also a cost benefit.

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell structure, comprising:
a membrane electrode assembly;
a polar plate mounted in a stacking direction for supplying a reactant to a surface of the membrane electrode assembly, the polar plate comprising an inlet media port as the inlet for the reactant and-a an outlet media port as the outlet for the reactant as well as a flow field which fluidically connects the inlet and outlet media ports, and an active area in which the electrochemical fuel cell reaction occurs during operation; and
a means for producing a region with a reduced reactant flow, which is provided on the inlet side of the flow field, wherein the means is located within the active area at an edge of the active area, or extends into the active area at the edge.

2. The fuel cell structure according to claim 1, wherein the flow field and the media ports are framed by a seal for lateral sealing off of the membrane electrode assembly, and the means extending into the active area is embedded in the seal.

3. The fuel cell structure according to claim 1, wherein the means is embedded in a gas diffusion layer situated between the polar plate and the membrane electrode assembly in the stacking direction.

4. The fuel cell structure according to claim 1, wherein the means is formed as at least one strip, extending at an angle relative to the surface normal of the surface of the membrane electrode assembly only partly into a usable flow cross section of at least one flow channel of the polar plate.

5. The fuel cell structure according to claim 4, wherein an extra plate is present between the polar plate and the membrane electrode assembly, comprising a plurality of strips protruding into the flow channels of the polar plate.

6. The fuel cell structure according to claim 4, wherein a series of strips is installed in at least one of the flow channels in the flow direction of the reactant flow.

7. The fuel cell structure according to claim 6, wherein the usable flow cross section of the flow channel provided by a first strip is smaller than that of a second strip situated downstream from the first strip.

8. The fuel cell structure according to claim 1, wherein the means is formed from a depression in the membrane electrode assembly at the edge.

9. A fuel cell stack having a plurality of fuel cell structures, each of the fuel cell structures comprising:
a membrane electrode assembly;
a polar plate mounted in a stacking direction for supplying a reactant to a surface of the membrane electrode assembly, the polar plate comprising an inlet media port as the inlet for the reactant and an outlet media port as the outlet for the reactant as well as a flow field which fluidically connects the inlet and outlet media ports, and an active area in which the electrochemical fuel cell reaction occurs during operation; and
a means for producing a region with a reduced reactant flow, which is provided on the inlet side of the flow field, wherein the means is located within the active area at an edge of the active area, or extends into the active area at the edge.

10. A motor vehicle having a fuel cell device comprising a fuel cell stack, the fuel cell stack having a plurality of fuel cell structures, each of the fuel cell structures comprising:
a membrane electrode assembly:
a polar plate mounted in a stacking direction for supplying a reactant to a surface of the membrane electrode assembly, the polar plate comprising an inlet media port as the inlet for the reactant and an outlet media port as the outlet for the reactant as well as a flow field which fluidically connects the inlet and outlet media ports, and an active area in which the electrochemical fuel cell reaction occurs during operation; and
a means for producing a region with a reduced reactant flow, which is provided on the inlet side of the flow field, wherein the means is located within the active area at an edge of the active area, or extends into the active area at the edge.
